(19) United States
(12) Patent Application Publication
(10) Pub. No.: US 2023/0267107 A1
(43) Pub. Date: Aug. 24, 2023

(54) GRAPHICAL REPRESENTATION OF AUTOMATED FEATURE ENGINEERING FOR FEATURE SELECTION

(71) Applicant: Michael Charles Mangarella, Sandy Hook, CT (US)

(72) Inventor: Michael Charles Mangarella, Sandy Hook, CT (US)

(21) Appl. No.: 18/093,592

(22) Filed: Jan. 5, 2023

Related U.S. Application Data
(60) Provisional application No. 63/296,522, filed on Jan. 5, 2022.

(51) Int. Cl. G06F 16/22; G06F 16/81

(52) U.S. Cl. CPC G06F 16/2237; G06F 16/81; G06F 16/221

(57) ABSTRACT

Systems and methods are provided that convert the output of automated feature engineering techniques into interpretable Boolean expressions that can be visualized as a connected feature graph.

### CROSS REFERENCE TO RELATED APPLICATIONS

This application claims priority to and incorporates by references U.S. Provisional Pat. Application Serial No. 63/296,522 filed on Jan. 5, 2022 and entitled OZY: GRAPHICAL REPRESENTATION OF AUTOMATED FEATURE ENGINEERING FOR FEATURE SELECTION

### BACKGROUND

Feature engineering can be defined as the process of manipulating and combining one or many raw data sources to produce informative data inputs for machine learning algorithms. In supervised learning, the goal of these algorithms is to predict a target variable through either classification or regression. A simple example of feature engineering for a classification problem would be to take the raw data for the closing price of a stock over the past 3 months, engineer a feature for the moving average of the stock over the previous 7 days, and use this feature as an input into an algorithm to predict the stock price for the next day.

Feature engineering is an inherently time intensive process, and has given rise to automated feature engineering, through open source libraries such as Featuretools. These libraries operate by understanding the type of data present in each column of the tabulated input dataset (i.e. String, Numeric), defining a set of functional transformations with an input and output type (i.e. the function LENGTH is applied to all String types and outputs a Numeric type), and then applying all functions to all columns with the corresponding input data type in the tabulated input dataset. This can essentially be thought of as computing the cross product between all columns and all functional transformations for each input data set, as seen in FIG. 1.

Though automated feature engineering is useful at generating many columns of candidate features, it still requires an efficient routine to determine which automatically generated features would be useful for a machine learning algorithm. This routine is commonly called feature selection. The feature selection process must be efficient and interpretable to prevent overfitting, data leakage, or systematic bias, which are all key challenges of automated feature engineering.

Using the stock predicting example again, a plausible automatically generated feature may be a simple Boolean expression such as “Stock name contains NV”, shown in FIG. 2. Though this feature may be highly predictive of stock price, intuitively it only captures the phenomenon that the stock NVIDIA has performed very well in the past and has a relatively unique combination of characters. Even though this is a trivial problem of interpretability, one can imagine how this interpretability challenge increases as data scientists attempt to select from millions of features generated from many different datasets with varying degrees of documentation.

It is with respect to these and other considerations that the various aspects and embodiments of the present disclosure are presented.

### SUMMARY

Systems and methods are provided that convert the output of automated feature engineering techniques into interpretable Boolean expressions that can be visualized as a connected feature graph.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an example of automated feature engineering;

FIG. 2 is an illustration of an example of automatically generated features with low utility;

FIG. 3 is an illustration of an overview of Ozy: graphical representation of automated feature engineering for feature selection;

FIG. 4 is an illustration of an example Boolean feature graph;

FIG. 5 is an illustration of Ozy modules and pseudo code; and

FIG. 6 shows an exemplary computing environment in which example embodiments and aspects may be implemented.

### DETAILED DESCRIPTION

This description provides examples not intended to limit the scope of the appended claims. The description is not to be taken in a limiting sense but is made merely for the purpose of illustrating the general principles of the invention, since the scope of the invention is best defined by the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Various inventive features are described herein that can each be used independently of one another or in combination with other features.

To solve this problem, this invention outlines a method to convert the output of automated feature engineering techniques into interpretable Boolean expressions that can be visualized as a connected feature graph. The Boolean simplification of automatically generated features allows a user to quickly discern each feature’s potential utility in a machine learning algorithm and the graphical representation allows a user to quickly interpret and understand potential systematic bias of a feature through its correlation to other feature expressions.

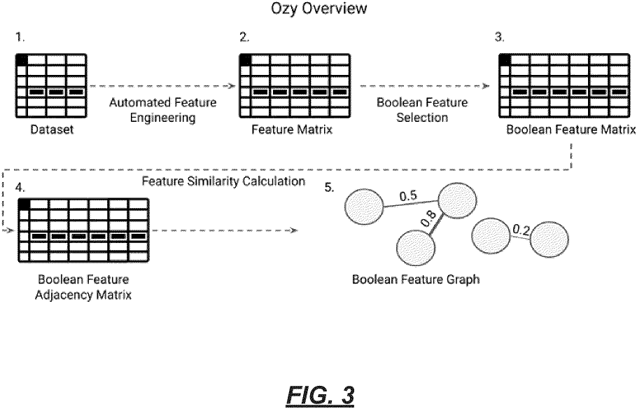

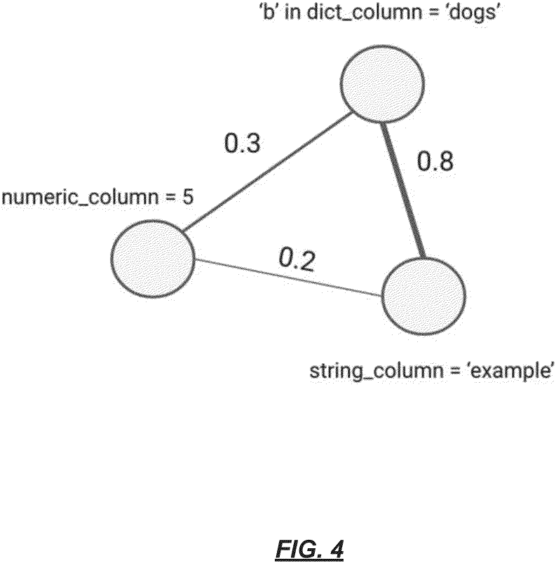

An overview of the invention can be seen in FIG. 3. Briefly, in 1. an initial tabular Dataset is selected that includes a target variable column and columns of semi-structured data. A series of functional transformations are automatically applied to the Dataset in 2. to generate a Feature Matrix, and then simple Boolean expressions are applied to this Feature Matrix to generate a Boolean Feature Matrix in 3. The similarity between all features in the Boolean Feature Matrix are calculated to generate a Boolean Feature Adjacency Matrix in 4. This serves as the input for the Boolean Feature Graph in 5.

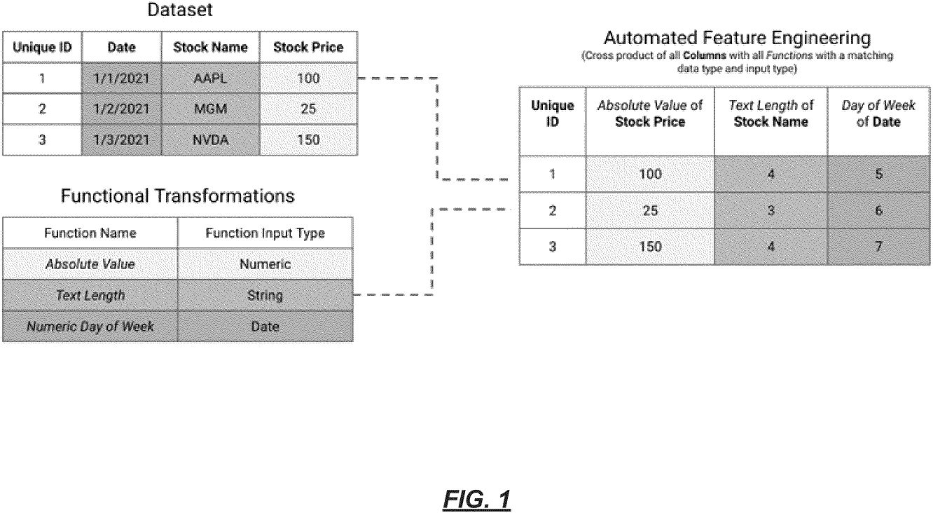

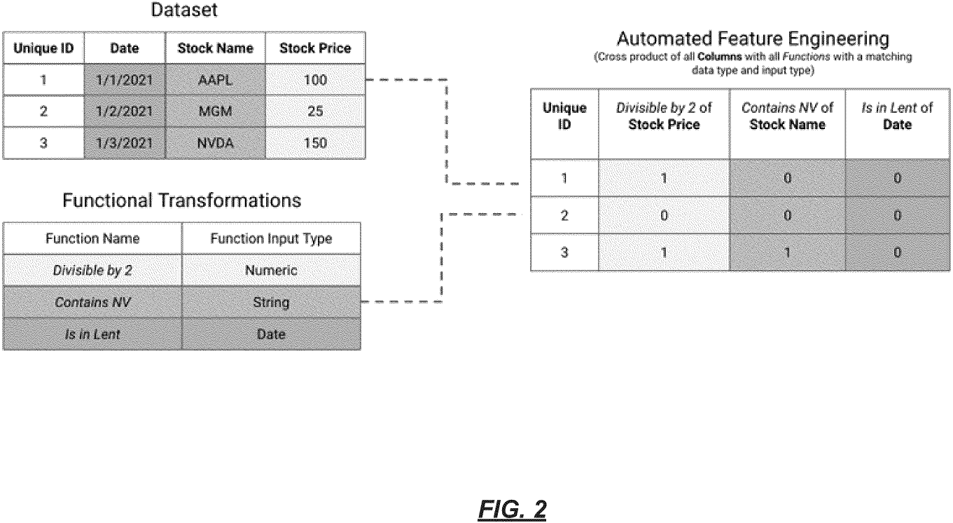

Features from an automated feature engineering algorithm, as seen in FIG. 1, are first simplified into Boolean expressions. This can be accomplished for all automatically generated features that are of type string, numeric, list (aka array), or dictionary (aka map), by iterating through the automatically generated features and exhaustively applying the Boolean expressions in Table 1.

TABLE 1

Example Creation of Boolean Features from Automatically Generated Features

| | | | |
|---|---|---|---|
| Automatically Generated Feature Type | Comma Separated Example Data | Boolean Expression | Example Boolean Feature |
| String | example1, example2, example3 | Equality | string_column = ‘example’ |
| Numeric | 1, 2, 3, 4 | Equality | numeric_column = 5 |
| Numeric | 1, 2, 3, 4 | Inequality | numeric_column > 5 |
| Numeric | 1, 2, 3, 4 | Range Inequality | numeric_column < 5 and > 2 |
| List | [‘a’, ‘b’] [‘a’ ‘c’], [‘a’, ‘d’] | Membership Check | list_column contains ‘a’ |
| Dict <Key, Numeric> | {‘a’: 1, ‘b’: 4}, {‘a’: 1, ‘b’: 3} | Numeric Equality | ‘a’ in dict_column = 1 |
| Dict <Key, Numeric> | {‘a’: 1, ‘b’: 4}, {‘a’: 1, ‘b’: 3} | Numeric Inequality | ‘a’ in dict_column > 1 |
| Dict <Key, Numeric> | {‘a’: 1, ‘b’: 4}, {‘a’: 1, ‘b’: 3} | Range Inequality | ‘a’ in dict_column < 3 and > 1 |
| Dict <Key, String> | {‘a’: 1, ‘b’: ‘cats’}, {‘a’: 1, ‘b’: ‘dogs’} | String Equality | ‘b’ in dict_column = ‘dogs’ |

The resulting Boolean features can be used to split a dataset into two datasets representing when the feature is True, and when the feature is False. The uncertainty of the target variable, as measured by gini impurity or entropy, can be measured before and after this split and can be used to measure if the Boolean feature decreases uncertainty of the target variable. The absolute or relative decrease of entropy, gini impurity, or other uncertainty metrics can be defined as information gain. The process of measuring this information gain from the prior to posterior distributions through the change in gini impurity or entropy is extremely similar to how a decision tree measures the quality of a split, and can be defined as Boolean Feature Selection.¹ This can result in a dataset, shown in Table 2, ranking the relative information gain of features, that can be used to prune low information Boolean features and automatically generated features that only resulted in low information Boolean features.

¹ https://scikit-learn.org/stable/modules/generated/sklearn.tree.DecisionTreeClassifier.html

TABLE 2

Ranked list of Boolean Features Derived from Automatically Generated Features

| Automatically Generated Feature | Example Boolean Feature | Information Gain |
|---|---|---|
| example1, example2, example3 | string_column = ‘example’ | 400 |
| 1, 2, 3, 4 | numeric_column = 5 | 300 |
| {‘a’: 1, ‘b’: ‘cats’}, {‘a’: 1, ‘b’: ‘dogs’} | ‘b’ in dict_column = ‘dogs’ | 200 |
| [‘a’, ‘b’], [‘a’, ‘c’], [‘a’, ‘d’] | list_column contains ‘a’ | 100 |

As this process can generate a large amount of Boolean features from each feature column, information gain or a similar metric can also be used to pick the best Boolean feature for each Boolean expression for each automatically generated feature.

Finally, the resulting high information Boolean features must be interpreted to prevent systematic bias, data leakage, and overfitting. Interpretability can be greatly increased by measuring and representing the correlation between all features in a set of features. The initial dataset of potential Boolean features with their value for each observation in the dataset can be represented below in Table 3 as a matrix of Booleans.

TABLE 3

Resulting Matrix of Boolean Features and Their Values

| | | | | |
|---|---|---|---|---|
| Observation # | numeric_column = 5 | string_column = ‘example’ | ‘b’ in dict_column = ‘dogs’ | ... |
| 1 | 0 | 1 | 0 | ... |
| 2 | 1 | 1 | 1 | ... |
| 3 | 0 | 0 | 1 | ... |
| ... | ... | ... | ... | ... |

Since all values for all features are Boolean, the correlation between all features can be measured using Jaccard Similarity, Cosine Similarity, or a similar similarity metric. This metric is defined here as the intersection of feature values for all observations over the union of feature values for all observations. Jaccard similarity can be used to measure if Boolean features have similar features values, and have a Jaccard similarity close to 1, or have dissimilar feature values, and have a Jaccard similarity close to 0. After completing this procedure, an adjacency matrix results that summarizes the similarity between all Boolean features and can be seen in Table 4.

TABLE 4

Resulting Boolean Feature Adjacency Matrix for the Similarity of all Boolean Features

| | | | | |
|---|---|---|---|---|
| | numeric_column = 5 | string_column = ‘example’ | ‘b’ in dict_column = ‘dogs’ | ... |
| numeric_column = 5 | 1 | 0.2 | 0.3 | ... |
| string_column = ‘example’ | 0.2 | 1 | 0.8 | ... |
| ‘b’ in dict_column = ‘dogs’ | 0.3 | 0.8 | 1 | ... |
| ... | ... | ... | ... | |

This adjacency matrix can be converted into a graph, where each node represents a Boolean feature and each edge represents the similarity between the two nodes. Additional metadata, such as the information gain of the Boolean feature node, can also be stored in the graph. Finally, to improve interpretability for the end user, an open source repository, such as pyvis², can create interactive graphical representations for all Boolean features that have a minimum similarity score. A user is now able to efficiently investigate clusters of features to discern if they are valuable phenomena or the result of systematic bias that should be learned by a machine learning algorithm. With this knowledge, the end user can take either the Boolean feature, or the automatically generated feature it was derived from, and use this as a feature. The Boolean Feature Adjacency Matrix in Table 4 results in the Boolean Feature Graph in FIG. 4.

² https://pyvis.readthedocs.io/en/latest/

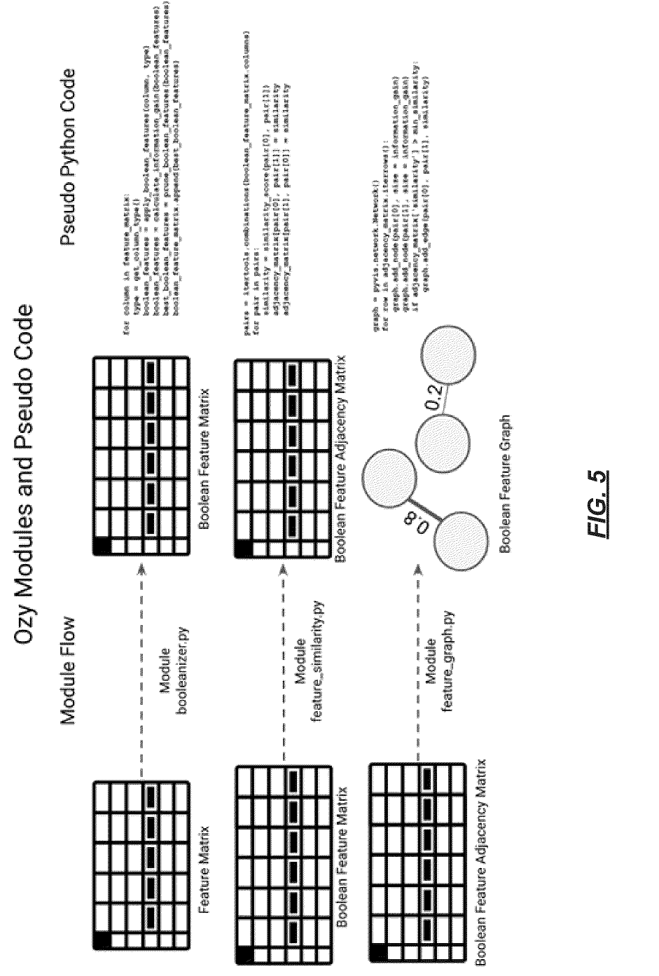

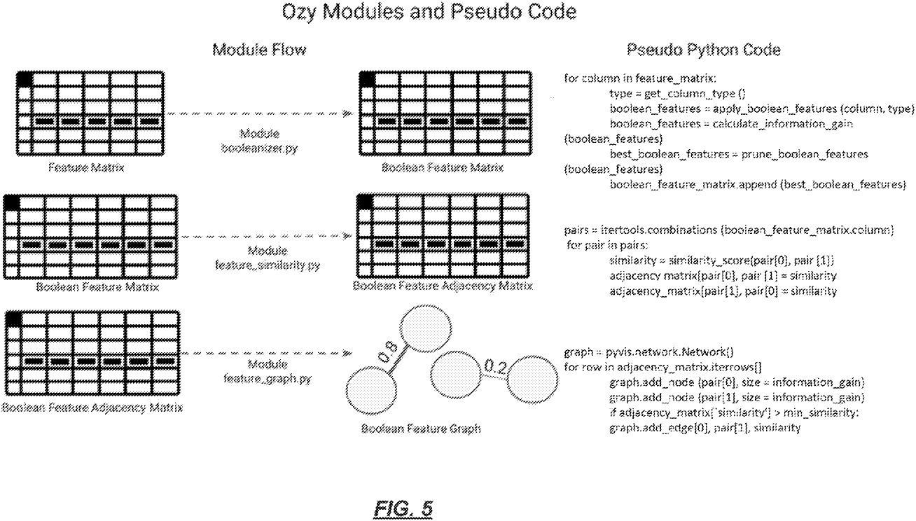

The modules and algorithms described above are also summarized in FIG. 5. The pseudo code is meant to broadly represent the inputs, outputs, and algorithms used in each module.

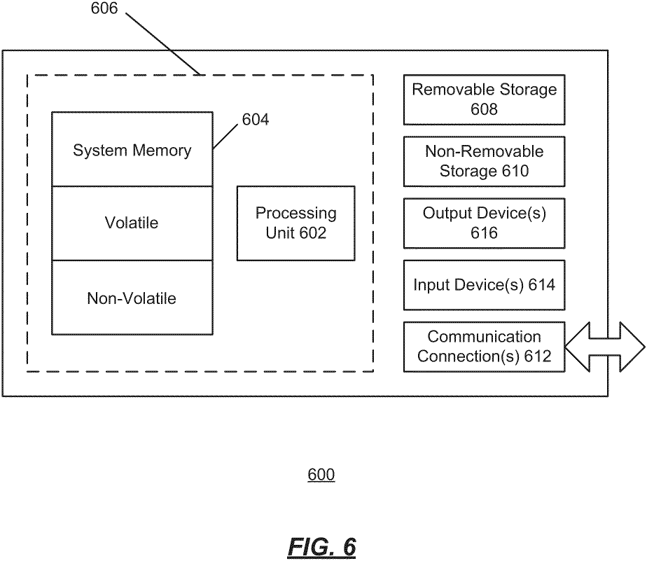

The various modules, techniques, methods, and algorithms described herein may be implemented using a variety of computing devices such as smartphones, desktop computers, laptop computers, tablets, set top boxes, vehicle navigation systems, and video game consoles. Other types of computing devices may be supported. A suitable computing device is illustrated in FIG. 6 as the computing device 600.

FIG. 6 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by the device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communication connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

As used herein, the singular form “a,” “an,” and “the” include plural references unless the context clearly dictates otherwise. As used herein, the terms “can,” “may,” “optionally,” “can optionally,” and “may optionally” are used interchangeably and are meant to include cases in which the condition occurs as well as cases in which the condition does not occur.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed.

Reference 1 is incorporated by reference herein as https://www.featuretools.com/.

Numerous characteristics and advantages provided by aspects of the present invention have been set forth in the foregoing description and are set forth in the attached Appendix A, together with details of structure and function. While the present invention is disclosed in several forms, it will be apparent to those skilled in the art that many modifications can be made therein without departing from the spirit and scope of the present invention and its equivalents. Therefore, other modifications or embodiments as may be suggested by the teachings herein are particularly reserved.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
selecting a dataset;
generating a feature matrix by applying transforms to the dataset;
generating a Boolean feature matrix using the feature matrix;
generating a Boolean feature adjacency matrix using the Boolean feature matrix; and
providing the Boolean feature adjacency matrix as input to a Boolean feature graph.

2. The method of claim 1, wherein the dataset comprises a target variable column and columns of semi-structured data.

3. The method of claim 1, wherein the transforms are functional transforms and are automatically applied to the dataset.

4. The method of claim 1, wherein generating the feature matrix comprises applying automated feature engineering to the dataset.

5. The method of claim 1, wherein the feature matrix comprises features received from an automated feature engineering algorithm.

6. The method of claim 5, wherein the features are of type string, numeric, list (aka array), and/or dictionary (aka map).

7. The method of claim 1, wherein generating the Boolean feature matrix comprises applying simple Boolean expressions to the feature matrix.

8. The method of claim 1, wherein generating the Boolean feature matrix comprises applying Boolean feature selection to the feature matrix.

9. The method of claim 1, wherein generating the Boolean feature matrix comprises iterating through automatically generated features and exhaustively applying Boolean expressions.

10. The method of claim 1, wherein generating the Boolean feature adjacency matrix comprises calculating the similarity between the features in the Boolean feature matrix.

11. The method of claim 1, wherein generating the Boolean feature adjacency matrix comprises performing a feature similarity calculation on the Boolean feature matrix.

12. The method of claim 1, wherein the Boolean feature graph comprises nodes and edges, wherein each node represents a Boolean feature and each edge represents the similarity between the two nodes.

13. The method of claim 12, wherein the Boolean feature graph further comprises the information gain of the Boolean feature node.

14. The method of claim 12, wherein the Boolean feature graph is limited to show only the most predictive and/or correlated features, by setting thresholds of information gain and/or similarity score.

15. The method of claim 1, further comprising investigating clusters of features to discern if they are valuable phenomena or the result of systematic bias that should be learned by a machine learning algorithm.

16-19. (canceled)
